(19) United States
(12) Patent Application Publication
(10) Pub. No.: US 2022/0262010 A1
(43) Pub. Date: Aug. 18, 2022

(54) BIOMECHANICAL TRACKING AND FEEDBACK SYSTEM

(71) Applicant: Ember Tech LLC, Reston, VA (US)

(72) Inventors: Fisnik Shpuza, Reston, VA (US); Michal Maik, Kraków (PL); Kamil Kryzk, Warsaw (PL)

(21) Appl. No.: 17/674,638

(22) Filed: Feb. 17, 2022

Related U.S. Application Data
(60) Provisional application No. 63/150,467, filed on Feb. 17, 2021.

(51) Int. Cl. G06T 7/20; G06V 40/20; G06V 20/40; G06V 10/75; A63B 24/00

(52) U.S. Cl. CPC G06T 7/20; G06V 40/23; G06V 20/48; A63B 2024/0012; G06V 10/751; A63B 24/0006; A63B 24/0062; G06V 20/46

(57) ABSTRACT

A computer-implemented method includes extracting movement data from a video of a user and identifying a movement type by providing the movement data to a classifier. The classifier is trained using data including bodily locations for multiple movement types including the movement type associated with the movement data. The method further includes comparing the movement data to target movement data for the movement type and providing feedback to the user based on the comparison between the movement data and the target movement data.

### CROSS-REFERENCE TO RELATED APPLICATION

This application is related to and claims priority under 35 U.S.C. § 119(e) from U.S. Patent Application No. 63/150,467, filed Feb. 17, 2021, and titled “BIOMECHANICAL TRACKING AND FEEDBACK SYSTEM”, the entire contents of which is incorporated herein by reference for all purposes.

### TECHNICAL FIELD

This disclosure relates to the capture, classification and evaluation of poses, movements, and other biomechanics. More specifically, aspects of the present disclosure are directed to providing real-time feedback to users as they perform movements, maintain poses, and the like.

### BACKGROUND

Computer-based systems for capturing and analyzing body movement have applications in a wide range of industries. For example, body movement tracking systems are used in the entertainment and video gaming industries for motion capture and for hands-free operation of gaming systems. Technicians also use systems that capture and analyze body movements in the sports and medical industries to assess user biomechanics and to measure user performance, such as in the context of physical therapy and rehabilitation. Significant issues regarding cost, accuracy, speed, and utility are persistent in known and conventional systems and it is with these issues in mind, among others, that led to the concepts and innovations disclosed herein.

### SUMMARY

A first aspect of this disclosure includes a computer-implemented method of analyzing bodily movement. The method includes extracting movement data from a video of a user and identifying a movement type by providing the movement data to a classifier. The classifier is trained using data including bodily locations for multiple movement types including the movement type associated with the movement data. The method further includes comparing the movement data to target movement data for the movement type and providing feedback to the user based on the comparison between the movement data and the target movement data.

Another aspect of this disclosure includes a system including a storage configured to store instructions and a processor configured to execute the instructions. When executed, the instructions cause the processor to extract movement data from a video of a user and identify a movement type by providing the movement data to a classifier. The classifier is trained using data including bodily locations for multiple movement types including the movement type associated with the movement data. The instructions further cause the processor to compare the movement data to target movement data for the movement type and provide feedback to the user based on the comparison between the movement data and the target movement data.

In yet another aspect of this disclosure a non-transitory computer readable medium is provided. The non-transitory computer readable medium includes instructions, that, when executed by a computing system, cause the computing system to extract movement data from a video of a user and identify a movement type by providing the movement data to a classifier. The classifier is trained using data including bodily locations for multiple movement types including the movement type associated with the movement data. The instructions further cause the system to compare the movement data to target movement data for the movement type and provide feedback to the user based on the comparison between the movement data and the target movement data.

### BRIEF DESCRIPTION OF THE DRAWINGS

FIG. 1 is a block diagram illustrating example operation of systems according to the present disclosure.

FIG. 2 includes graphical representations of movement data illustrating application of processes according to the present disclosure for improving inter-class separation.

FIG. 3 includes graphical representations of movement data illustrating application of processes according to the present disclosure for improving intra-class compactness.

FIG. 4 illustrates a system environment according to an example of the instant disclosure.

FIG. 5 is a flowchart of a method for capturing and analyzing biometric data according to an example of the instant disclosure.

FIG. 6 is a flowchart of a method of preprocessing data for use in training and evaluating models for a movement type classifier.

FIG. 7 is a flowchart of a method of generating, evaluating, and selecting models for implementation in a movement type classifier.

FIG. 8 shows an example of a system for implementing certain aspects of the present technology.

### DETAILED DESCRIPTION

Aspects of the present disclosure are directed to systems for capturing and analyzing movements. In certain implementations, the systems and methods disclosed herein may capture and evaluate biometric data corresponding to a user. Based on the captured biometric data, the movement of the user may be identified (e.g., by determining start and end poses of the movement and classifying the poses) and evaluated (e.g., by determining how closely the movement performed by the user corresponds to an ideal or target movement). In general, implementations of the present disclosure may be used to analyze full body biomechanics; however, it should be appreciated that aspects of the present disclosure may also be used to analyze biomechanics of specific body parts or areas.

In at least certain implementations, the system captures biometric data using a camera of a computing device. Example computing devices include, but are not limited to, smartphones, tablets, or laptops, or desktop computers. The capturing computing device may also perform the classification and evaluation. Alternatively, at least a portion of the classification and evaluation may be conducted by a computing system (e.g., a server system) in communication with the computing device, e.g., over the Internet or via a local connection.

Functionality described herein may be facilitated by one or more artificial intelligence systems and/or machine learning algorithms. For example, and among other things, one or more machine learning algorithms may be used to identify locations on a user's body; normalize a captured image of the user to a standard frame of reference; classify a movement performed by the user; and/or evaluate how closely a user's movement tracks a target movement. Machine learning models described herein may be trained using any suitable techniques that are currently known and/or that may be later developed. For example, machine learning models may be provided with predefined training data. However, in certain implementations, such training data may be replaced by or supplemented with actual user data from a specific user or from a broader network of users of the system described herein.

In one specific example, a classifier may determine what movement a user is performing and/or particular positions for a given movement, such as a starting or ending position. Classifiers implemented in systems disclosed herein may be trained on initial training data consisting of movement data corresponding to an idealized movement pattern (e.g., an exercise movement) and variations thereof (e.g., low range of motion variations of the exercise). As one or more users attempt to perform the movement, the users may generate additional movement data that is collected and used to further train the classifier. The classifier may therefore be trained on the ideal form of a given movement but also on data representing attempts by actual users to perform the movement. As a result, the classifier may be trained on a broader data set and may more accurately determine what movement a user is performing even if the user is executing a movement in a non-ideal manner.

In certain implementations, a classifier or other model may be developed for a specific user. In some cases, such a model may be stored and trained locally on the user's computing device. Alternatively, the model may be stored remotely from the user's computing device, but may be exclusively trained on data received from the user. In either case, such model customization may generally result in models that have better fit with respect to the particular user.

In at least some implementations, models may be trained on a combination of movement data obtained from a specific user and movement data obtained from other users. Accordingly, the resulting model would be a “hybrid” model for a particular user that relies on both user-specific and collective user data. In such systems, movement data may be assigned varying weights according to source. For example, and without limitation, movement data obtained from the user associated with the model may be given a greater weight than collective movement data.

In at least certain implementations, the classifier may utilize a triplet loss regularizer create the embedding space for determining a user's movement. In an alternative implementation, the embedding space may be created using a variational encoder. In some cases, the triplet loss regularizer may also implement hard negative mining. As further described below, the triplet loss regularizer may restructure the embedding space in such a way that it increases intra-class compactness while also maximizing inter-class separation. Stated differently, the triplet loss regularizer results in a classifier that is better able to identify a specific movement and to distinguish between different movements.

In addition to determining what movement a user is performing, aspects of the present disclosure may also evaluate how well a user performs a particular movement. Such evaluation may be conducted per repetition of a movement, over a set of repetitions, across an entire workout, or any other suitable scope. To do so, the biometric data of the user may be compared to a target movement (also referred to herein as an “ideal” or “golden”, movement), which generally corresponds to a preferred movement pattern for the movement/exercise being performed. Such comparison may include normalizing the biometric data to a standard frame of reference (e.g., by applying an affine transformation) and determining differences between the movement data collected from the user and that of the target movement. In certain implementations, comparison between the user's movement and the target movement may be conducted substantially in real-time and may be used to provide feedback to the user during the course of a movement. Alternatively, comparison between the user's movement and the target movement may be conducted on a repetition-by-repetition or similar basis, e.g., by giving the user a score or similar metric following completion of a movement repetition.

In certain implementations of the present disclosure, analysis of a user's movement may be conducted at a video frame level. Such analysis may include calculating and evaluating the distances between corresponding points of the captured movement data and the target movement data. Such frame-by-frame analysis may be used to provide substantially immediate feedback (e.g., using visual or audio cues/alerts) to the user, such as by visually indicating/highlighting a particular limb having a position that differs from the target movement data by more than an acceptable threshold. In at least some implementations, the frame-by-frame data for a given repetition may be collected and processed to provide feedback, such as a score or grade, for the repetition. Among other techniques, the score/grade may be calculated by calculating a total or average distance metric for the frames corresponding to the repetition exceed and comparing such distance metrics to thresholds corresponding to different scores/grades.

Systems in accordance with the present disclosure may be used to provide feedback and guidance to a user regarding a given movement or pose. Among other possible applications involving movement and performance comparison, aspects of the present disclosure may be used to determine, compare, and provide feedback regarding a user's range, adherence, and speed of motion as compared to a target movement. Accordingly, the present disclosure has applications in the fields of gaming, fitness, performance, sports training, physical therapy, and various medical fields, among many others.

Although other applications of the present disclosure are contemplated, one example application of the present disclosure is in the field of physical therapy and rehabilitation. For example, a physical therapist, a personal trainer, or similar individual may use the system disclosed herein to assign a set of movements, poses, or similar exercises to a patient that the patient is to perform on their own as part of a therapy/rehabilitation program. When the patient performs the assigned exercises, the patient may use a camera and corresponding computing device (such as a standard front-facing camera available on a smartphone) to capture video of the patient performing the assigned exercises. As the user performs the exercises, the system may identify the exercise being performed, provide feedback to the user (including feedback provided in substantially real time), track the patients' completion of the assigned exercises, and the like. In alternative implementations, the process of identifying a user's movement may be omitted and a user may instead select an exercise, a series of exercises, be assigned one or more exercises, etc. Among other things, the tracked data for a patient may include whether a patient has completed the prescribed type and quantity of exercises (e.g., as prescribed by a physical therapist or other medical professional) as well as the general quality of the patient's movements (e.g., as compared to a “golden” or target movement). In at least certain implementations, the tracked information for the patient may be summarized in a report or similar analysis and provided to the patient and/or made available to the therapist to further develop the patient's recovery.

In light of the foregoing example, systems in accordance with the present disclosure capture, analyze, and provide feedback related to movements of a user. Although useful in physical therapy applications and for purposes of facilitating relationships between two or more parties that have a data driven physical motion adherence and performance feedback basis, the systems disclosed herein may more generally be used for any applications relying on the capture and analysis of user movement using a readily available computing device, such as a smartphone including a camera.

Referring back to the physical therapy example for context only and without limitation, the therapist may assign a series of exercises to be performed at some regular interval by the patient/user. For each exercise, the system stores information associated with a recommended or idealized form and/or execution of the exercise. Among other things, the stored information for a given exercise may include a series of data points corresponding to target locations of body parts throughout execution of the exercise. Accordingly, as the system captures corresponding data points for the user as the user performs the exercise, the system may compare the user's data against the target data to evaluate how well the user has performed the exercise. Such comparison may also be used to provide feedback to the user regarding potential improvements to the user's form and execution. In addition to target data points for the exercise, the system may also store images, videos, text descriptions, audio, etc. for the exercise that may be presented to the user for purposes of guiding/coaching the user.

In certain implementations, feedback and media associated with a given exercise may be presented to the user via a display of the computing device used for capturing the user's movement, e.g., a smartphone. However, any suitable device may be used to facilitate communication and interaction with the user. For example, communication and feedback may be provided to the user via a mobile app, a virtual headset, a television/monitor, a brain-machine interface (e.g., Neuralink), haptic feedback devices, or any other devices adapted to provide user feedback.

It should also be appreciated that while systems in accordance with the present disclosure rely primarily on biometric data extracted from frames of video, such biometric data may also be supplemented by additional biometric movement data collected from sensors of other devices. For example, and without limitation, biometric data extracted from video may be supplemented with data collected from movement sensors (e.g., accelerometers, gyroscopes), physiological sensors (e.g., heart rate sensors, blood pressure sensors, etc.), neurological activity sensors, and the like that measure activity of the user.

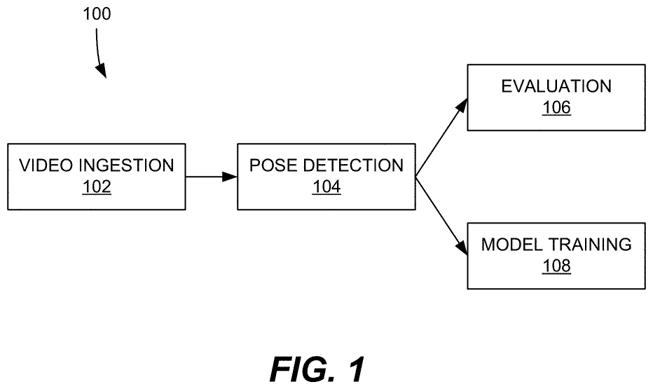

Example operation of systems according to the present disclosure is provided in FIG. 1. As illustrated, the basic workflow 100 begins by capturing video data (such as raw video data) of the user (step 102), e.g., using a camera set up by the user, as the user performs a particular exercise. The captured video data is then transmitted to a computing device (e.g., a smartphone) for pose detection (step 104) and subsequent evaluation. Pose detection generally refers to the process of extracting body position data from the video.

The system may generally use data obtained during pose detection in two ways. First, the system may perform an evaluation on the data, e.g., to assess a user's movement (step 106). In certain implementations, evaluation may include a frame-by-frame evaluation (or a similar evaluation using a multi-frame step size) of the data obtained during pose detection. Among other things, evaluation may include comparing the data from pose detection to a target or “golden” movement for each or a subset of the frames of data. The system may also or alternatively evaluate data obtained during pose detection on a repetition-by-repetition basis.

Data obtained from pose detection may also be used to facilitate development and training of machine learning and other AI-based models (step 108). For example, the system may use data obtained during pose detection to test, train, or otherwise develop a neural network (or similar machine learning model) to automatically identify the exercise or movement being performed in the video (e.g., as an anchor, positive example, or a negative example of the movement).

Among other AI-driven components, systems according to this disclosure may include a classifier configured to automatically identify an exercise being performed by a user based on the data obtained during pose detection. In the context of evaluation, the system may rely on the classifier to determine an exercise being performed by the user such that the system may retrieve corresponding data (e.g., target movement data) for analyzing the user's movements, accurately log/report the user's exercise, and the like. In the context of model training, the system may rely on the classifier to determine the exercise being performed by the user such that the corresponding data from pose detection may be accurately categorized for subsequent use in training, testing, etc., models related to the exercise.

Each of the foregoing steps and additional aspects of the system disclosed herein is described below in further detail.

In at least certain implementations, as the user performs a given exercise, a pose detection neural network may process captured frame images of the user and may return a set of key points, each corresponding to a location on the user's body. As this process may occur for each frame, key point data for the user may be captured multiple times per second. Among other things and without limitation, key point data may be captured indicating the location of the user's eyes, ears, nose, neck, throat, shoulders, elbows, wrists, hips, pelvis, knees, ankles, heels, toes, or any other body part. In certain implementations, the neural network provides the key point data as a list of x- and y-coordinate pairs, each pair representing a location of a given body location as include in the video frames. In certain implementations, if a key point is not visible within the frame, the neural network may return a negative value (or similar value indicating that the key point is not within the frame). The neural network may also apply a linear regression (or similar interpolation/extrapolation) that calculates coordinates for key points that may not be visible within the video frame (e.g., due to being obscured within the frame or located outside of the frame). Processing the captured frame in the foregoing manner helps ensure that subsequent models are provided with acceptable biometric data.

Although implementations of the present disclosure are directed primarily to whole-body applications, it should be understood that the present disclosure may also be applied to more discrete portions of the body. Such portions may include, among other things, the upper body only, the lower body only, individual limbs, individual body parts, and the like. Depending on the applications, the key points used for processing and analysis may vary. For example, in one application, a system according to the present disclosure may be used to analyze a user's hand movement. In such an application, examples key points may include the wrist, palm center, fingertips, finger joints, knuckles, and other similar identifiable physical features of the hand.

Certain implementations of the present disclosure may further include a neural network model (or similar machine learning model) configured to identify and capture a starting position for an exercise performed by a user. For example, after key points have been analyzed and modified (e.g., if they were obscured or outside of frame), the key point data is then converted into input for another trained neural network model responsible for identifying and capturing a starting position for the current exercise. In certain implementations, the starting position model takes the input biometric data and identifies the starting position of the user based on target movement data (e.g., by determining when the user biometric data indicates that the user is within a certain range of a starting target position), based on instructions provided to the user, based on identifying a cyclical/repetitive pattern in the user biometric data, or a similar process.

In at least certain implementations, the starting position model is implemented with a trained embedding created on a relatively small amount of data that includes only a few labelled videos. Such an embedding may be used, for example, to effectively distinguish between the starting positions for different users for a given movement. In general, a significant problem for conventional classification approaches is the immense amount of data required to develop the model. As a result of such quantities of data, training such a model is computationally expensive and time consuming. Approaches in accordance with the present disclosure, however, provide a way to both decrease the amount of data needed (thereby decreasing the computation- and time-related costs) while increasing the overall quality and accuracy of the resulting model.

Another issue associated with conventional classification approaches is the ability of such conventional models to distinguish between inputs that may have only subtle differences. For example, in the context of movements, conventional classification models may have difficulty distinguishing between starting and ending positions of a relatively small movement. To address such issues, implementations of the present disclosure may implement a triplet loss function (or other similar function) that effectively learns a similarity measure between like movements. By implementing triplet loss (or a similar mechanism), each of intra-class compactness and inter-class margins may be improved, thereby improving the ability to classify movements.

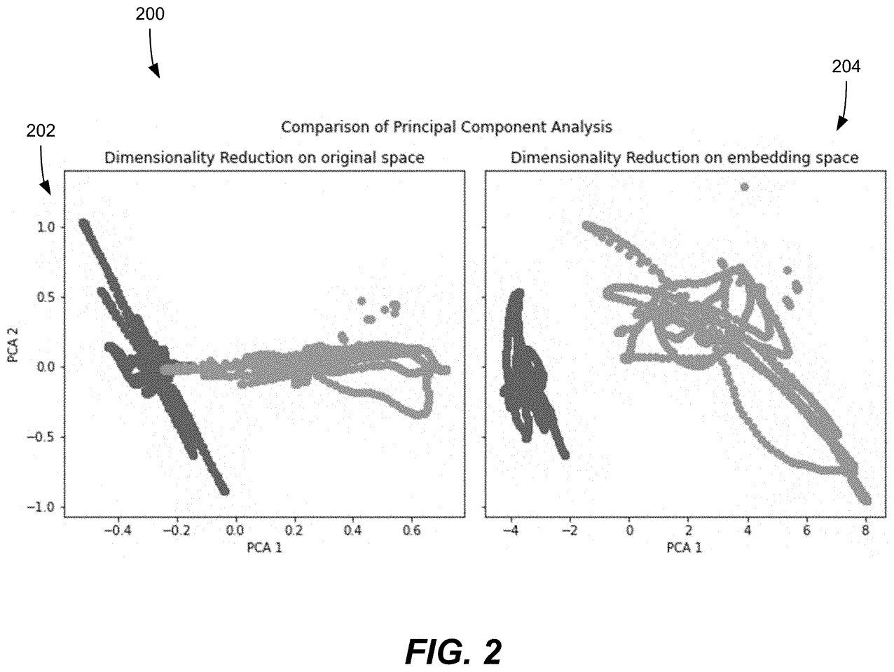

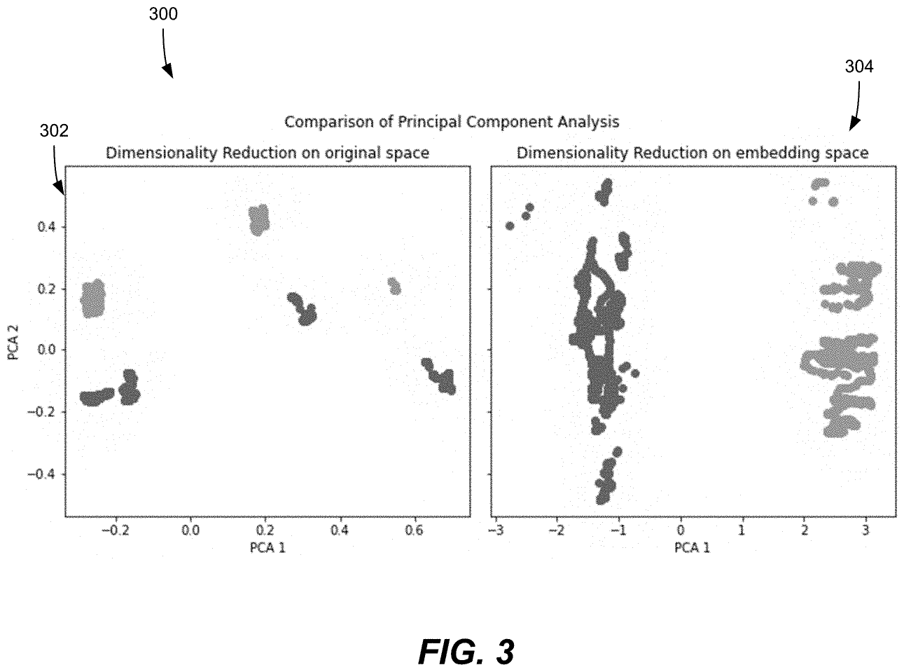

To further illustrate concepts of the present disclosure, FIGS. 2 and 3 illustrate examples of how user positions may be dispersed across regular space and an embedding space. It should be appreciated that, while the data of FIGS. 2 and 3 are illustrated in a two-dimensional space, implementations of the present disclosure may be based on multi-dimensional spaces (e.g., multi-dimensional spaces in which each dimension represents body locations (absolute or relative) of a user). For example, each of FIGS. 2 and 3 were generated by applying a principal component analysis (PCA) of a higher-dimensional space representing a user's body positions to reduce data in the higher-dimensional space into a two-dimensional representation.

As illustrated in data visualization 200 of FIG. 2, techniques according to the present disclosure, when applied to movement data were able to increase inter-class separation. More specifically, the left graph 202 of FIG. 2, illustrates two classes with at least partial overlap. By applying the techniques disclosed herein, the classes were completely separated, thereby improving classification accuracy and efficiency, as illustrated in the right graph 204 of FIG. 2.

FIG. 3 similarly includes an example visualization 300 of data in an original space (left graph) and a transformed space (right graph), as generated using the techniques disclosed herein. As shown, in the original space (left graph 302), the data has good separation (e.g., no overlap), albeit in multiple, small clusters. By applying the techniques herein and as shown in the right graph 304 of FIG. 3, an embedding space may be generated that increases intra-class compactness. As a result, subsequent classification is improved.

In at least certain implementations of the present disclosure, the training process for the embedding space and classifier may be enhanced in various ways. First, data augmentation may be used to enlarge the dataset by implementing translation, reflection, scaling and perturbation. By implementing such augmentation, a very small original dataset (e.g., on the order of 1000 records) may be used to generate significantly more records (e.g., a 10-fold increase). Such augmentation may be done “on the fly” and with random processes in order to guarantee diverse, non-repeating batches of records that improve generalization of the underlying model without overfitting.

Using the foregoing technique, a fully trained model can be created quickly and efficiently, particularly as compared to conventional model training techniques. The general process for generating a fully trained model may include each of generating a set of augmented data, training the embeddings of the model, training the classifier, and testing the model. In the context of movement data, this approach enables a new type of exercise to be added to the model with only a few labeled videos.

In at least certain implementations, hyperparameter optimization (e.g., grid search) may also be implemented to identify optimal hyperparameters and model architectures.

Following generation of a model, it may be checked, e.g., using a model evaluation script and/or test data.

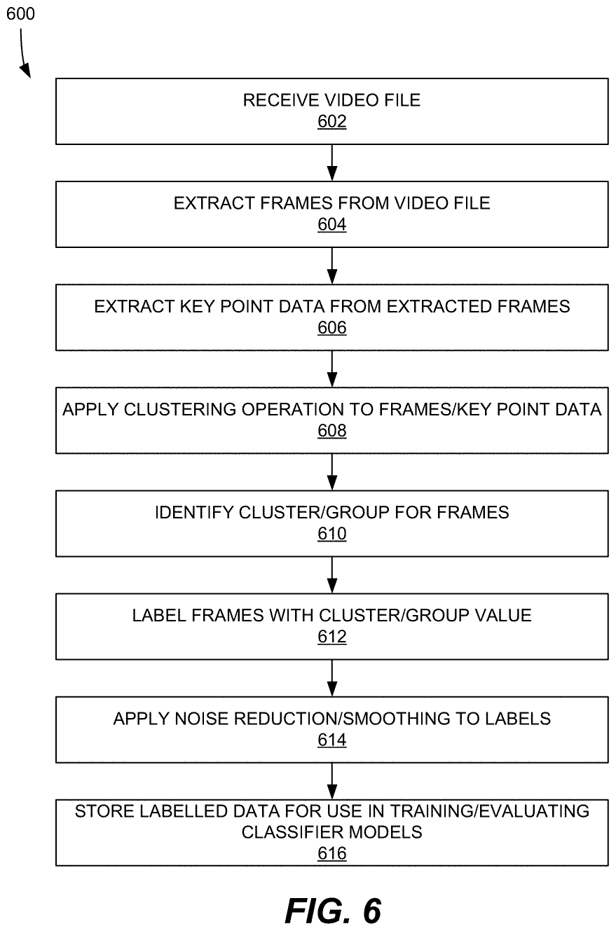

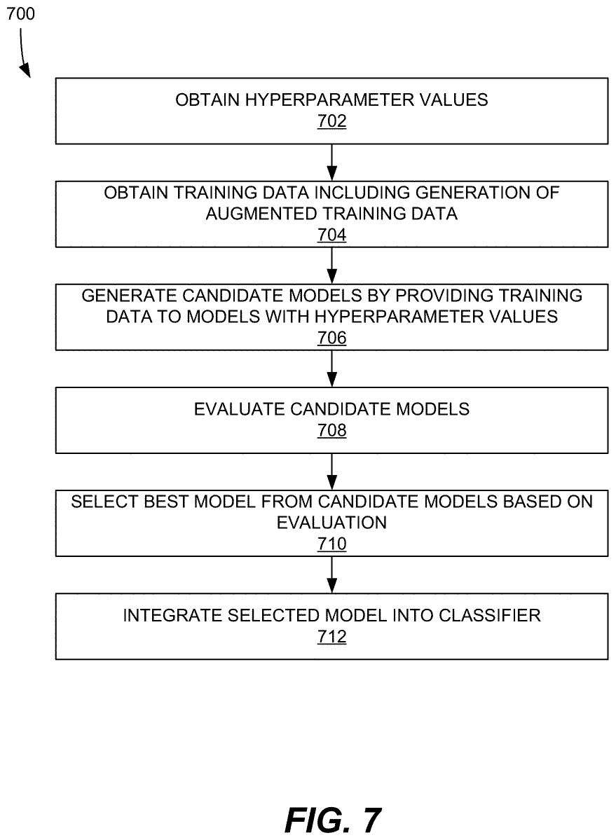

This disclosure provides additional details and examples of automatic model generation and related data labelling in the context of FIGS. 6 and 7, below.

In certain implementations, evaluation of a user's biometric data may include comparing the biometric data to a target or “golden” example of the movement being performed by the user. In general, such a comparison may include aligning the user's biometric movement data to the target movement data (e.g., by aligning a starting position identified in each data set). Such alignment may include scaling of the user or target biometric data to account for differences in body geometry, movement pace, etc. For example, an affine transformation may be applied to the user movement data to project a “skeleton” corresponding to the user movement data onto a corresponding skeleton of the target movement data or vice versa. In addition to aligning the user biometric data and target data, either data set may be time-shifted and/or time-scaled to account for differences in movement speeds, start/end times for a repetition, etc. For example, the user movement data may be time-shifted to align a “start position” frame of the user movement data to a corresponding start position frame of the target movement data, or vice versa.

Time scaling of either data set may be also be performed such that the duration of a repetition of the user movement data is the same as the duration of a repetition of the target movement data. For example, after aligning start position frames, end position frames for each of the target movement data and the target movement data may be aligned. Such alignment may be achieved by removing/deleting frames of movement data, e.g., when the user movement data or target movement data represents a slower repetition than the target movement data or the user movement data, respectively. Alternatively, frames of data may be added to the user movement data or target movement data when it represents a faster repetition than the target movement data or user movement data, respectively. In certain implementations, doing so may involve generating a frame of movement data to be inserted between two frames by interpolating between the movement data of the two frames.

Once aligned (including any scaling, etc.), the user biometric data is compared to the target movement data. For example, key point data for one or more frames of the user biometric data is compared to key point data for corresponding frames of the target movement data. The comparison is generally used to generate a metric indicating how closely the user's movement corresponds to that of the target. Such a metric may, for example, include a Euclidean distance (or some other distance measurement) between the user's biometric data and the corresponding target data.

As previously noted, in certain implementations, one or both of the user movement data and the target movement data may be scaled or otherwise modified as part of the comparison process. In at least certain implementations, one set of data may be projected onto the other for purposes of facilitating comparison. For example, one or more affine transformations may be applied to the target data such that the target data may be adjusted to account for the user's specific body type. Alternatively, a similar transformation may be made to the user biometric data to conform the user biometric data to the target data. In at least certain implementations, the affine transformations may be applied such that certain fixed distances are made to be substantially equal in the target data and the user data. For example, in certain implementations, an affine transformation may be determined by identifying how three points on the user's body must be modified to conform to similar points of the target movement data. The scaling, etc. required to transform the three points on the user's body to those of the target movement data may then be used as a basis for determining scaling for other body parts and dimensions.

The user's movements may be tracked and evaluated as discussed above throughout the course of an entire exercise and for one or more repetitions. As a result, feedback may be provided to the user in substantially real-time. In certain implementations, feedback may be provided by a visual indicator presented on the computing device, such as a score. Feedback may also be provided for purposes of suggesting corrections to the user. For example, the user's computing device may provide a live image of the user over which form corrections are overlaid (e.g., arrows indicating body parts to move, lines/bars indicating proper limb positions, etc.). Notably, feedback may be provided to the user mid-repetition (e.g., showing a user how to correctly complete a repetition), following a repetition (e.g., indicating how accurately/successfully the user completed the previous repetition), following multiple repetitions (e.g., indicating an overall score for the exercise), and the like. Performance data for the user may also be shared with other users. For example, the user's performance data or various metrics derived therefrom may be shared with the user's physical therapist or other healthcare professional that may have prescribed an exercise/rehabilitation regime to the user. By doing so, the healthcare professional may determine whether and how well a user is able to perform the prescribed exercises such that the healthcare professional may make any necessary modifications to the user's treatment plan.

As previously noted, evaluation may include tracking and comparison of frames between the user data and the target data in substantially real time. In one example process, a Euclidean distance for each key joint/point is calculated. To the extent the calculated distance exceeds a given threshold, the user's computing device may issue a warning (e.g., an audio and/or visual warning) or other feedback for the user to correct his or her position. Similar analysis can be performed for the angles formed between the points.

In implementations of the current disclosure, feedback may be provided for individual points/joints, combinations of joints, or larger body segments (up to and including the user's entire body).

When evaluating an entire repetition, the entire movement of each individual joint may be compared. As previously noted, in at least certain implementations, a time shift, scaling, or similar transformations may be applied to the user's movement data to align the user's movement data with the target movement data. Doing so enables better evaluation of the user in cases where the user's movements do not perfectly align with those of the target data (e.g., if the user executes the movement faster or slower or at a different frequency than the target data). In one specific example, after data for a repetition is aligned with the corresponding target data, a cross-correlation function is applied to generate a similarity measure (e.g., between 0 and 1) between the user's movement data and the target movement data. Again, this evaluation may be a joint-by-joint basis and therefore can provide very detailed information of where the most improvement is needed.

In at least certain implementations, an entire exercise may be assessed by averaging evaluation metrics for individual joints over multiple repetitions. Such data may be used, for example, to rank which parts of the body most closely matched the target data over the full performance of the exercise. These individual averages can again be grouped into a single value between 0 and 1 that provides a total evaluation score for the exercise. Ultimately, as the user continues to perform the exercises (e.g., on a daily or other periodic basis), the user can review their scores and determine what, if any, changes in their form/execution need to be made. As a result, the systems and methods disclosed herein facilitate continuous review and improvement by the user.

The systems and methods disclosed herein have wide-ranging applications. In addition to physical therapy/rehabilitation, the processes disclosed herein can be used by trainers or coaches to assess the movements and development of their athletes. For example, a set of exercises can be assigned by the trainer to the athlete and the athlete's performance can be tracked over time. As another example, yoga instructors can be more certain that their students are executing positions properly at home by having them monitored using the systems and methods herein. Doing so can help reduce the risk of injury, particularly when the user/student is also provided with a visual example (e.g., a video) of the target movement/position with which the user may follow along. Accordingly, systems and methods according to the present disclosure can also be used to provide guidance and improve the road to recovery for physical therapy patience, but also help in guiding other trainer/student relationships towards goals of self-improvement while helping to minimize injury caused by improper exercise execution.

In the specific context of physical therapy, the systems and methods disclosed herein also provide significant value to physical therapy practitioners, trainers, and the like and, in doing so provide high-value exchanges between users and physical therapy practitioners. Among other things, the systems and methods disclosed herein provide high quality data-driven evaluations that reduce the need for monitoring and adjustment-related activities while simultaneously improving the ability of therapists to identify prescriptive solutions.

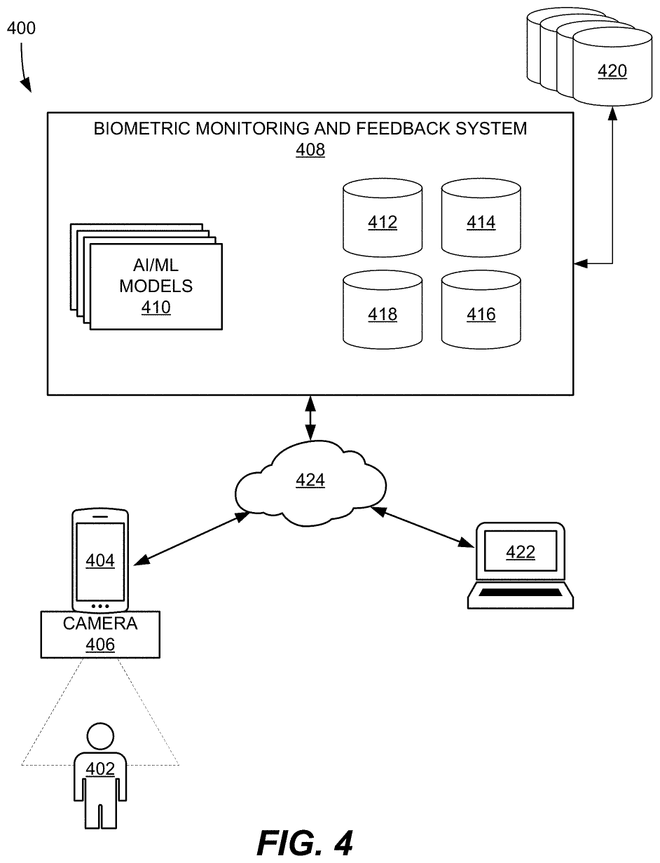

FIG. 4 illustrates a system environment 400 according to the present disclosure. System environment 400 includes a user 402 operating a user computing device 404. Among other conventional computing components, user computing device 404 includes a camera 406 such that videos (e.g., in the form of a sequence of images/frames) may be captured by user computing device 404. Although illustrated in FIG. 4 as being a smartphone, user computing device 404 may be any suitable computing device that includes a camera (either integrally or as a connected peripheral). Other examples of computing devices include, without limitation, laptop computers, desktop computers, tablets, “smart” appliances (e.g., smart TVs), “smart” fitness equipment (e.g., smart mirrors), and the like.

User computing device 404 may execute software (e.g., a program or app) that facilitates communication with a biometric monitoring and feedback system 408 for purposes of tracking and analyzing movements of user 402, e.g., over a network 424, such as the Internet. In at least certain implementations, biometric monitoring and feedback system 408 may be implemented using one or more servers that host services, applications, etc., associated with a rehabilitation, fitness, or other application including movement tracking and analysis. In certain implementations, biometric monitoring and feedback system 408 may be implemented using a cloud-based architecture.

During operation, user 402 records video of him- or herself executing an exercise (e.g., a movement or pose). Key point data is then extracted from the video and analyzed to determine what exercise user 402 is performing and/or how well user 402 is performing the exercise (e.g., how closely execution of the exercise by user 402 tracks to a target execution of the exercise). The results of the analysis may then be presented to user 402 via user computing device 404. Among other things, such presentation may be provided using audio, visual, haptic, or any other type of feedback available based on the output modalities of user computing device 404. For example, with respect to visual feedback, user computing device 404 may display an alphanumeric metric/score to user 402 during or following an individual repetition of an exercise or series of repetitions. In another implementation, user computing device 404 may display a mirror image of user 402 with one or more overlays illustrating correct form or specific corrections user 402 should make. In still other implementations, similar feedback may be provided in the form of audio cues (e.g., “slow down”, “keep your back straight”, “make sure your feet are shoulder-width apart”, etc.). Any such feedback may be provided after an exercise or rep or substantially in real-time to user 402. User 402 may also be able to access summaries, reports, etc. of exercises performed by user 402.

In addition to computing components for executing instructions and communicating with user computing device 404, the biometric monitoring and feedback system 408 may train, store, test, generate, update, or otherwise support one or more artificial intelligence/machine learning (“AI/ML”) models 410. As a first example, an AI/ML model of AI/ML models 410 may receive as input frames of video collected using camera 406. The AI/ML model may then identify key points within the frames corresponding to bodily locations of user 402. As another example, an AI/ML model of AI/ML models 410 may receive as input the key point data and identify the movement being performed by user 402. Yet another AI/ML model of AI/ML models 410 may analyze the collected key point data by comparing it to target data for the identified movement. More generally, however, the biometric monitoring and feedback system 408 may include any suitable AI/ML models for use in performing any of the tasks described herein.

Biometric monitoring and feedback system 408 may also store various types of data. As illustrated in FIG. 4, for example, biometric monitoring and feedback system 408 may include an exercise data source 412, a user information data source 414, a user performance data source 416, and a training data source 418. Exercise data source 412 may store, among other things, data related to exercises that may be assigned to, selected by, accessed by, or otherwise presented to the user 402 through user computing device 404. Among other things, such exercise data may include multimedia explaining or illustrating an exercise (e.g., instructional text, videos, images, audio, etc.), key point data corresponding to a target movement for the exercise, and the like. User information data source 414 may store general user information including personal information, health-related information, exercise/fitness goals, and the like for each user associated with biometric monitoring and feedback system 408. User performance data source 418 may store data related to exercises performed by users of biometric monitoring and feedback system 408. For example, and without limitation, user performance data source 418 may store video (complete or individual frames) received from users, key point data extracted from videos of users, performance metrics generated by analyzing user movements, and the like. Training data source 418 may include training data for purposes of training one or more of AI/M L models 410. Such training data may be directly provided to biometric monitoring feedback system 408, extracted from exercise data, extracted from user-related data (e.g., key point data collected from users performing exercises), generated from user-related data (e.g., using the augmentation technique discussed above), and the like. Biometric monitoring feedback system 408 may also have access to one or more external data sources 420 containing data for various other purposes. For example, external data sources 420 may include exercise, nutrition, fitness, or other similar health-related data sources for supplementing information generated by biometric monitoring feedback system 408, or social media-related data sources for retrieving and posting user-related information.

System environment 400 further includes a secondary user computing device 422. In at least certain implementations, secondary computing device 422 may be used by a health professional or other similar use to access biometric monitoring feedback system 408. Among other things, secondary computing device 422 may be used to create an exercise program (e.g., by assigning exercises and parameters of those exercises to the user 402) and to review/analyze performance of any assigned exercise programs. For example, in at least certain implementations, a physical therapist may assign a series of exercises to a user and monitor whether the user has completed the assigned exercises along with an analysis of how well the user completed the assigned exercises.

System environment 400 illustrates just one example of operational environments for systems and methods according to the present disclosure and other environments are contemplated. For example, and among other things, implementation of the present disclosure may combine the functionality of biometric monitoring and feedback system 408 with user computing device 404 into a single device or may distribute functionality described herein between any suitable number of computing devices.

Moreover, while system environment 400 includes only one each of user computing device 404 and secondary computing device 422, implementations of the present disclosure may support any number of user computing devices and secondary computing devices. For example, in certain implementations, biometric monitoring and feedback system 408 may analyze movements and provide feedback to many users, each using a respective user computing device. Notably, data collected and processed from one user may be used to supplement functionality for other users. For example, and without limitation, data collected from one user may be used to train or otherwise improve any of AI/ML models 410.

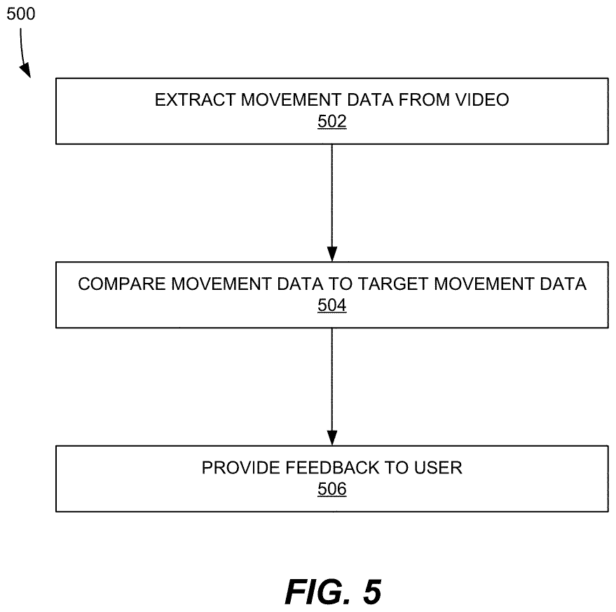

FIG. 5 illustrates an example method 500 for collecting, analyzing and providing feedback for user movements. Although the example method 500 depicts a particular sequence of operations, the sequence may be altered without departing from the scope of the present disclosure. For example, some of the operations depicted may be performed in parallel or in a different sequence that does not materially affect the function of the method 500. In other examples, different components of an example device or system that implements the method 500 may perform functions at substantially the same time or in a specific sequence.

According to some examples, the method includes extracting movement data from a video of a user at step 502. For example, camera 406 of user computing device 404 illustrated in FIG. 4 may record a video of user 402 consisting of multiple frames and from which movement data may be extracted. User computing device 404 may then extract movement data from the video. Alternatively, the video may be transmitted to biometric monitoring and feedback system 408, which, in turn, extracts the movement data.

In certain implementations, extracting movement data includes generating user key point data from the video that indicates bodily locations of user 402 per the video frames. In at least certain implementations, generating the user key point data includes identifying the bodily locations of the user in each frame of the video. In at least certain implementations, such identification may be performed by a neural network, machine learning model, or similar model adapted to identify bodily locations from images of people. For example, identification of the bodily locations may include providing each frame to the model which generates a set of points (e.g., coordinate pairs) indicating where various bodily locations are positioned within the received frame.

In at least certain implementations, processing the video data may further include transforming first location data (e.g., sets of coordinate pairs) corresponding to the bodily locations of the user relative to the frame into second location data corresponding to the bodily locations of the user relative to a standard frame of reference. Such transformation may be applied to account for variations in user position (e.g., distance, rotation) relative to camera 106, which facilitates subsequent comparison to target data for the exercise being performed by the user.

In certain implementations, one or more affine transformations may be applied to the location data generated by the previously discussed model to transform the location data into a standard frame of reference. Affine transformations are one technique used to warp one “space” (e.g., that of the video frame) into another (e.g., a standard space for use in comparing user exercise data to target data). An alternative technique may include remapping each point identified in the user movement data to corresponding points of the target movement data, e.g., using a regression algorithm. Such an approach may be implemented, for example using machine learning to continually improve and refine the regression algorithm, etc. to improve the mapping of the user movement data to the target movement data.

In one example technique, substantially fixed bodily locations may be used to define a triangle that is subsequently identified in each of a first data set (e.g., the user data) and a second data set (e.g., the target data). The points of the triangle may be selected to correspond to bodily locations that generally indicate body size and shape. In one non-limiting example, the triangle may be defined by three points corresponding to each of the feet and the head. As another example, the three points may correspond to each of the shoulders and the pelvis. As yet another example, the three points may include each of the hips and the center of the head. One or more of the operations (e.g., scaling, translation, rotation, etc.) necessary to transform the triangle in the first data set into that of the second data set may then be identified and, once identified, applied to the remainder of the first data set, effectively projecting the first data set onto the second data set. As a result, data collected from a user that may be standing at a particular location or orientation relative to the camera can be transformed as if the user were at the same location and orientation of target exercise data (or data from another user). Doing so significantly improves the speed and accuracy with which comparisons between the user data and the target data may be made.

It should be appreciated that, while the foregoing example relies on a single triangle (i.e., an affine transformation using a single triangle), other implementations may instead use multiple triangles or any suitable n-sided polygon (i.e., a projective transformation) to project the user movement data onto the target movement data (or vice versa). For example, a first triangle may be used for the upper body while a second triangle may be used for the lower body. As another example, a 4-point polygon may be used for the transformation, which may generally permit more accurate scaling/projection, particularly in cases where the user's body proportions may differ significantly from those of the target movement data.

In certain cases, not all bodily locations of a user may be visible. Accordingly, extracting movement data from the video may include extrapolating user key point data for any bodily locations not visible within the frame. Extrapolating the user key point data for the bodily location not visible within the frame may include applying linear regression, or similar extrapolation technique to the other user key point data for one or more bodily locations contained within the frame.

According to some examples, the method includes classifying the movement data to identify a movement type corresponding to the movement data at step 502. For example, user computing device 404 or biometric monitoring and feedback system 408 illustrated in FIG. 4 may execute a classifier model (or other similar AI/ML model, e.g., of AI/ML models 410) to which the movement data is input and that classifies the movement data to identify a movement type corresponding to the movement data. Identifying a movement type may generally include identify what particular exercise user 402 is attempting to perform.

The classifier may be trained on one or more sets of movement data, each set of movement data indicating bodily locations during performance of a movement. In at least certain implementations, the classifier is trained using a triplet loss function, such as triplet loss with hard negative mining. Triplet loss is a technique most often connected with facial recognition software and provides a method of training models to distinguish between images, including frames of video. In the context of facial recognition, triplet loss relies on three input images: an anchor image (e.g., Person A), a positive image (also Person A), and a negative image (Person B). Over the course of training, the model learns an embedding space where images of Person A all reside in a clustered subspace. The same happens for person B and so on. Such a space can contain and distinguish between hundreds, if not thousands of individual persons.

Similarly, movement data may be used to train a model using triplet loss. More specifically, anchor position data (e.g., position data of example movement data for a particular exercise) may be compared with positive position data (e.g., position data of movement data for a user performing the particular exercise) and negative position data (e.g., position data of movement data for a user having different positions during performance of the exercise). As additional comparisons are made, the model learns an embedding space where position data for the particular exercise resides in a clustered subspace. Notably, to the extent the anchor position data corresponds to an ideal/target movement, the clustered subspace associated with the exercise would be broader and, as a result, would still correctly classify position data corresponding to attempts at the exercise even if those attempts are not executed perfectly. Moreover, as position data for a particular exercise is provided, the model may be able to identify and separately classify common variations on the exercise. For example, a model initially trained to identify a squat may be refined to separately classify a normal/full-depth squat and a low-mobility/reduced-depth squat.

With the addition of hard negative mining, one can improve the performance of the triplet loss model by training on the best possible triplets. The technique forces triplets to be chosen in such a way that the negative image is closer to the anchor than the positive image. This forces the model to create the embedding space in such a way as to push the negative images farther away while pulling the positive images closer.

Other uses for triplet loss such in the present disclosure include metric learning and rank regularization. Nevertheless, triplet loss (particularly when combined with hard negative mining) allows creation of an embedding space with good intra-class compactness and inter-class distance.

In certain instances, user 402 may preselect a particular exercise and, as a result, classification of the movement data to determine what movement user 402 is performing or attempting to perform may be unnecessary. Nevertheless, the selection made by user 402 may be used to provide training data (e.g., positive movement data for a triplet loss function) for the classifier. More generally, movement data extracted from video of user 402 may be used, in whole or in part, to train any suitable AI/ML model of AI/ML models 410 of systems and methods disclosed herein.

According to some examples, the method includes comparing the movement data to target movement data at step 504. For example, user computing device 404 or biometric monitoring and feedback system 408 illustrated in FIG. 5 may compare the movement data extracted from the previously captured video to target movement data. In general, the target movement data is generally movement data associated with a “golden” or ideal execution of the exercise being performed by user 402.

In at least certain implementations, such comparison may include temporally aligning the movement data to the target movement data. Such alignment may include identifying a starting position from the movement data and aligning the starting position of the movement data with a starting position of the target movement data.

Comparison of the user movement data with the target movement data may also require temporally scaling the user movement data and/or the target movement data. For example, the user movement data may indicate that the user completed a particular repetition of an exercise in 4 seconds; however, the target movement data may be based on execution of a 5 second repetition. In such cases, one or both of the target movement data may be temporally compressed, or the user movement may be temporally extended. Among other things, temporal compression may include modifying timestamps of movement data to reduce the time between samples, deleting frames, and the like. Similarly, and among other things, temporal extension may include modifying timestamps of movement data to increase the time between samples, inserting new frames, and the like. Inserting a new frame may further include generating movement data, e.g., by interpolating between movement data of adjacent frames.

Once aligned, differences between the movement data and the target movement data may be identified. For example, in certain implementations, a Euclidian distance (or similar distance metric) may be calculated based on the differences between key points in the movement data and the target movement data. Among other things, such differences may be based on the location of key points, the distance between key points, the angles formed between different key points, and any other suitable geometric/spatial relationships of the key points, whether individually or in combination.

Despite the foregoing, in at least certain instances, the pace at which a given movement is performed may be a fundamental aspect of correctly executing the movement. Accordingly, while at least certain exercises may allow for temporal scaling as discussed above, others may include pacing as a metric when evaluating/scoring a repetition, set, etc. In still other implementations, temporal scaling may be implemented, but only to a certain extent. Stated differently, temporal scaling may be applied to account for at least some pacing deviation; however, if the deviation exceeds a particular threshold, the system may consider the deviation in its analysis of the user's movement and the feedback provided to the user.

In certain implementations, movement data associated with a particular frame of video may be compared to one or more portions of the target data. Stated differently, movement data for an index (e.g., a relative time for a repetition) corresponding to a given frame may be compared to target movement data at or around a corresponding index of the target data. In implementations in which the target movement data is compared to target movement data for multiple indices, a distance metric may be calculated between the user movement data and each set of target movement data, resulting in a collection of distance metrics. A final distance metric may then be calculated (e.g., an average distance metric) or selected (e.g., a minimum or maximum distance metric) from the collection.

According to some examples, the method includes providing feedback to the user based on the comparison between the movement data and the target movement data at step 506. For example, the user computing device 404 or biometric monitoring and feedback system 408 may provide feedback to user 402 based on the comparison of step 504.

Feedback may be provided during the course of a repetition (e.g., in substantially real-time), following completion of a repetition, following completion of multiple repetitions, following completion of an exercise, or any combination or variation of such timeframes. Feedback may also be provided that compares repetitions, sets of repetitions, exercises, etc. to previously performed repetitions, sets of repetitions, exercises, etc. For example, during a repetition, feedback may be provided to user 402 that confirms user 402 is completing the repetition with good form (e.g., display of a green indicator or playing of positive/encouraging audio) or that provides corrections to user 402 (e.g., display of a yellow or red indicator or playing of audio that provides suggestions/cues for form correction). As another example, following a repetition, user 402 may be provided with a score (e.g., a numerical score, letter grade, etc.) indicating how successfully user 402 completed the repetition. A similar score may be provided to user 402 following completion of a set of repetitions for a particular exercise. In at least certain implementations, feedback may be provided to user 402 in the form of visual indicators overlaid on live video playback of user 402. Such visual indicators may include, for example and without limitation, an overlay for one or more limbs indicating correct form/position, arrows or other symbols indicating corrections to be made by user 402 as user 402 executes the repetition.

Implementations of the present disclosure may include one or more feedback modalities including, but not limited to, visual, aural, and haptic feedback. For example, in implementations in which user computing device 404 is a smartphone, visual feedback may be provided to user 402 on a display screen of user computing device 404, aural feedback may be provided by speakers of user computing device 404, and haptic feedback may be provided by a vibration or similar module.

In at least certain implementations, user computing device 404 may be configured to play a video or similar media illustrating execution of an exercise. Such media may generally correspond to the target movement data and, in some cases, may be used as the source of the target movement data. During execution of an exercise, user 402 may be presented with the media such that user 402 may follow along with the media. User computing device 404 and/or biometric monitoring and feedback system 408 may then determine, based on a comparison of the user movement data to the target movement data, that user 402 is executing the exercise at a different pace than as presented in the media. In response, user computing device 404 and/or biometric monitoring and feedback system 408 may alter the playback speed of the media to more closely match the pace of user 402. For example, if user 402 is executing the exercise slowly, user computing device 404 and/or biometric monitoring and feedback system 408 may slow playback of the media. Alternatively, if user 402 is executing the exercise quickly, user computing device 404 and/or biometric monitoring and feedback system 408 may speed up playback of the media.

As noted above, analysis of a user's movement may include automatically determining the exercise a user is performing. To do so, systems according to this disclosure may provide movement data extracted from a video of a user to a classifier configured to identify what exercise the user is performing based on the movement data. In at least certain implementations, once an exercise is identified, the system may then compare the user's movement data to idealized data for the exercise to determine how well the user performed the data, to count repetitions by the user, and other functions described herein.

The classifier may rely on multiple models, each corresponding to a different movement pattern or pose. In certain implementations, the movement pattern or pose may correspond to a particular exercise. However, to improve and broaden functionality of the systems disclosed herein, the classifier may include additional models to automatically identify variations of particular exercises. For example, in a relatively simple application, the classifier may be configured to recognize a particular exercise (e.g., a squat) but in a more advanced application, the classifier may be configured to distinguish between types of the exercise (e.g., wide stance/sumo squat, close stance squat, half-squat, jump squat) or modified versions of the exercise (e.g., low range-of-motion, slow speed, etc.). Given the breadth of movement patterns that the classifier may need to distinguish between, there is a need for an automatic and efficient way to generate new models for incorporation into the classifier. There is also a need that any such models are highly accurate, particularly given that the classifier may be required to distinguish between movement patterns and poses that may only have slight variations.

To facilitate generation, training, and evaluation of models, systems according to the present disclosure may preprocess movement data intended for use in developing models. Among other things, preprocessing may include dividing a video of a movement into individual frames and generating movement data by identifying bodily locations (e.g., key points) within each frame. A clustering algorithm may then be applied to each frame that identifies a closest key position to the frame. The frame may then be labelled accordingly such that the movement data in combination with the label may be used in generating, training, updated, etc. a model corresponding to the movement performed in the video. In at least certain implementations, a noise reduction or smoothing process may also be applied to the labelled data to identify and correct errant labels.

The foregoing process is illustrated in FIG. 6, which illustrates a method 600 of preprocessing data for use in training, evaluating, etc. models for use in classifiers of systems according to the present disclosure. The following example is described as being executed by biometric monitoring and feedback system 408; however, it should be understood that the following method may be executed separately from biometric monitoring and feedback system 408 with the resultant labelled movement data later provided to biometric monitoring and feedback system 408 for training/generation of models.

At step 602, biometric monitoring and feedback system 408 receives a video file and, at step 604, splits video file into separate frames. In certain implementations, step 604 may include identifying and splitting out each frame of the video received in 602; however, in other implementations, biometric monitoring and feedback system 408 may be configured extract only a subset of the frames included in the video received in step 602. In one specific example, biometric monitoring and feedback system 408 may automatically identify and trim portions of the video that do not include the user. In another example, biometric monitoring and feedback system 408 may be configured to identify a portion of the received video in which the user remains substantially still for several frames and may trim the preceding and/or subsequent frames. Also, while the current example method assumes that each frame of the received video is subject to preprocessing, biometric monitoring and feedback system 408 may be configured to process only periodic frames (e.g., every other frame, every third frame, etc.), such as to conserve resources or reduce preprocessing time.

At step 606, biometric monitoring and feedback system 408 extracts key point data for each frame. As discussed herein, key point data generally includes coordinates within a frame for each of a set of bodily locations and may include providing the frame to a key point identification model configured to receive a frame including a user and to automatically identify key points within the frame.

At step 608, biometric monitoring and feedback system 408 may apply a clustering operation generated in step 606. The clustering operation of step 608 receives the key point data for each frame and groups the frames based on the similarity of the user's position in the frames.

In certain implementations, the number of groups may be predefined and may correspond to key positions in a movement/exercise. For example, if biometric monitoring and feedback system 408 is generating preprocessed data for a conventional squat exercise, biometric monitoring and feedback system 408 may execute step 608 to divide the frames into two groups. The first group may include all frames that show the user in or near a standing position while the second group may include all frames that show the user in or near an “at-depth” position. As another example, if biometric monitoring and feedback system 408 is generating preprocessed data for a curl and press exercise, biometric monitoring and feedback system 408 may execute step 608 to divide the frames into three groups. The first group may include all frames that show the user in or near a position in which the curl is extended, the second group may include all frames that show the user in or near a position in which the curl is contracted, and the third group may include all frames that show the user in or near the overhead press position of the exercise.

Although the number of groups may be predetermined, in at least certain implementations, biometric monitoring and feedback system 408 may automatically determine the number of groups into which the frames are to be divided, i.e., the number of key positions in a given movement. In many exercises, the individual performing the exercise may pause or rest at specific positions in the exercise (e.g., the standing and at-depth positions in a squat). Given that a larger proportion of video frames in which a user performs the exercise will show the user in or near the pause/rest positions, applying a clustering operation to such frames may produce groups corresponding to the pause/rest positions, obviating the need to provide a specific number of groups ahead of time.

At step 610, biometric monitoring and feedback system 408 determines the group/cluster to which each frame belongs and, at step 612, applies a corresponding label to each frame. Although the specific way of determining a group and label for a frame may differ based on the specific clustering algorithm implemented by biometric monitoring and feedback system 408, in at least certain implementations, a frame's group may be determined by the proximity of the frame's key point data to centroids of clusters identified during the clustering operation. Stated differently, biometric monitoring and feedback system 408 may label a frame based on the group/cluster having a centroid closest to the frame. For example and referring back to the squat example, a frame may be labelled with a “0” if it shows the user in or near the standing position and a “1” if it shows the user in or near the “at-depth” position.

At step 614, biometric monitoring and feedback system 408 may apply a noise reduction or smoothing operation to the labelled data. In general, the noise reduction/smoothing operation may include identifying and correcting/removing outliers from the labelled data.

In general, the labels applied by biometric monitoring and feedback system 408 in step 612 should exhibit long sequences of labels with relatively abrupt changes between labels. Using the prior example of a squat and its corresponding labels, biometric monitoring and feedback system 408 may label frames for a squat movement as “0” for all frames depicting the user in a position between the standing position and mid-point of the squat and “1” for all frames depicting the user in a position between the mid-point and full depth. Based on this labelling scheme, when viewed sequentially, the labels for the squat will include alternating strings of continuous 0's and 1's with relatively abrupt changes between label values.

In certain cases, biometric monitoring and feedback system 408 may improperly label a given frame. The causes of mislabeling by biometric monitoring and feedback system 408 may vary, but in at least certain cases may be caused by shadows or other events captured in the video and idiosyncrasies in models used to determine key points within frames.

To address mislabeling, biometric monitoring and feedback system 408 may execute a noise reduction/smoothing operation in which biometric monitoring and feedback system 408 identifies and corrects mislabeled frames. As noted above, when labels are viewed sequentially, they should exhibit long strings of label values with abrupt changes between label values. Based on this relative consistency, mislabeled frames will generally appear in the sequence of labels as a short sequence. For example, a short sequence of a first label (e.g., “1”) between longer strings of a second label (e.g., “0”) may be considered errant and subject to correction.

Considering the foregoing, biometric monitoring and feedback system 408 may be configured to automatically analyze the sequence of labels generated in steps 610 and 612, to identify short errant sequences, and to relabel the corresponding frames. The specific number of labels considered errant and persistent may differ in applications according to the present disclosure; however, in at least certain implementations and without limitation, biometric monitoring and feedback system 408 may consider a sequence of three or fewer instances of a first label to be errant if it is both preceded and followed by five or more instances of a second label. In such cases, biometric monitoring and feedback system 408 may change the instances of the first label to the second label, thereby correcting the mislabeling.

The foregoing is just one example of a noise reduction/smoothing operation that may be used by biometric monitoring and feedback system 408. In general, any suitable technique may be applied to reduce noise and/or smooth the data generated in step 610 and step 612 to provide improved consistency and accuracy of the data.

At step 616, biometric monitoring and feedback system 408 may store the labelled data for subsequent training/evaluation of models.

In addition to preprocessing data for use in training and evaluation of models, implementations of the present disclosure may include automatic model selection for models used in classifying user movements (i.e., models configured to receive key point data from one or more frames of a video and to identify the movement being performed in the video). In at least certain implementations, automatic model selection may include generating a range of models for a particular movement, evaluating each generated model, and selecting the best performing model for integration into the classifier.

Each model in the range of models may be based on a different combination of model parameters/hyperparameters and evaluated using an automatically generated set of training data. In at least certain implementations, training data may be based on original movement data (such as generated by method 600, above) obtained directly from a video but may further include augmented movement data resulting from applying various transformations to the original movement data.

The foregoing process is illustrated in FIG. 7, which illustrates a method 700 for generating a model for use in a classifier for identifying user movement types from videos. Like method 600, biometric monitoring and feedback system 408 may perform method 700. Alternatively, a separate computing system may perform method 700 and provide the resultant model to biometric monitoring and feedback system 408 for integration into the movement classifier.

At step 702, biometric monitoring and feedback system 408 obtains multiple values for one or more hyperparameters used in generating a set of candidate models. Although any meaningful hyperparameter may be varied in method 700, in at least certain implementations, the hyperparameters of step 702 may include a neural network early stopping patience and a learning rate for a gradient descent optimizer. For each hyperparameter of 702, biometric monitoring and feedback system 408 may select one or more values. For example, in one specific example and using the hyperparameters noted above, biometric monitoring and feedback system 408 may select three different stopping patience values and two different learning rate values, resulting in six unique hyperparameter combinations.

Notably, to the extent a hyperparameter is not included in step 702 (i.e., a hyperparameter does not form the basis of variation between candidate models), such a hyperparameter may be hardcoded or otherwise predetermined. Accordingly, step 702 may further include retrieving a table or similar store of hyperparameter values for use in generating the set of candidate models.

At step 704, biometric monitoring and feedback system 408 obtains training data for candidate models. In certain implementations, the training data may include labelled movement data as obtained from a video (e.g., using method 600 of FIG. 6). In other implementations, biometric monitoring and feedback system 408 may augment labelled movement data to expand the training data set.

Augmenting the labelled movement data may include applying one or more transformations to the key point data of the labelled movement data. As previously discussed, the key point data generally indicates the position of a bodily location of a user in a given frame. Augmenting such data may include applying one or more transformations to the key point data to artificially generate training data that may reflect variations in user proportions, position, execution, etc. Notably, the transformations applied to the key point data are generally selected such that any label is preserved.

The specific transformations applied to the training data may vary; however, in at least certain implementations, transforming key point data may include one or more of: flipping coordinates for key points about an axis (e.g., flipping about the y-axis), adding noise to key point coordinates, displacing all key points by a fixed amount, increasing or decreasing scaling of the key points (e.g., to mimic zooming in or out), reversing a subset of key points (e.g., key points corresponding to limbs), and the like. Notably, transformations may be fixed/static (e.g., displacing all key points by a fixed amount to mimic a user being in a different part of a frame) or may include some randomness (e.g., adding randomized “noise” to some or all of the key points). Regardless of whether parameters for a given transformation is static or includes a random element, biometric monitoring and feedback system 408 may select transformation parameters from within a range that is realistic (e.g., a range that does not result in unnatural body proportions or displacements) or that otherwise reflects known and measured variations in data. For example, key points may “jitter” about a coordinate despite a user and frame remaining substantially. In light of this, noise applied to key point data to generate augmented training data may be based on a distribution of jitter measurements collected from different sources.

In certain implementations, biometric monitoring and feedback system 408 may generate multiple sets of augmented training data. For example, biometric monitoring and feedback system 408 may generate a “simple” augmented training data set in which a first set of transformations is applied to movement data and an “advanced” augmented training data set in which a second, larger and more complex set of transformations is applied to the same movement data.

At step 706, biometric monitoring and feedback system 408 provides the data obtained in step 704 to models based on the hyperparameters selected in step 702 to generate candidate models. To the extent biometric monitoring and feedback system 408 generates multiple sets of augmented training data, each set of augmented training data may form the basis of a respective model. Stated differently, biometric monitoring and feedback system 408 may use different sets of augmented training data in combination with different hyperparameter values (see step 702, above) to further broaden the range of candidate models. For example, in the preceding example in which biometric monitoring and feedback system 408 generates six combinations of hyperparameters (from three different stopping patience values and two different learning rates), biometric monitoring and feedback system 408 may use each of a “simple” and an “augmented” training data set for each combination of hyperparameters to generate a total of twelve unique models.

At step 708, biometric monitoring and feedback system 408 evaluates the candidate models using evaluation data. In general, evaluation data is movement data in which the appropriate label for each frame is known. Accordingly, evaluation of each model generally includes providing the key point data form the evaluation data and determining whether and how the output of the models is consistent with the known labels.

Evaluating a model may include determining the overall accuracy of the model. For example, each model may be configured to receive movement data and, for each frame of movement data, to provide a value between the label values of the movement data. So, for example, if labels can be either “0” or “1” to indicate the nearest key position (e.g., for squats “0” may be standing and “1” may be at-depth”, each model may output a value between 0 and 1. Such values may then be rounded to the nearest whole number and compared to the known labels of the evaluation data to determine the general accuracy of the model.

Evaluating a model may also include determining a “confidence” of each model. As noted above, each model may output a value between certain label values (e.g., 0 and 1). The degree to which a model's output approaches one of the label values may be considered a measure of the model's confidence. For example, a model that outputs a value of 0.9 may be more confident that a model that outputs a value of 0.65 despite both values being rounded to 1 in the preceding accuracy evaluation.

Evaluating a model may also include determining a level of persistence or “noisiness” of each model. As noted above in the context of method 600, frames may be labelled with a value indicating the closest key position to the key position in the frame. When the labels of frames are viewed sequentially, the labels typically include long sequencies of particular values followed with relatively abrupt changes between values. To the extent a long sequence of a first label value is interrupted by a short (e.g., three or fewer instances) sequence of a second label value, the second label value may be considered an error/noise. Accordingly, when evaluating a model, biometric monitoring and feedback system 408 may determine the quantity, frequency, magnitude, or other aspect of such errant labelling. Stated differently, models exhibiting fewer occurrences of mislabeling or noise may be considered more stable.

The foregoing are provided merely as examples of how the candidate models may be evaluated. More generally, biometric monitoring and feedback system 408 may evaluate each of the candidate models using any suitable metric or criterion.

In certain implementations, the training data provided to each model may include one or more repetitions of a movement. In instances where multiple repetitions are included, evaluation may be based on a best repetition, a combined total of all repetitions, an average across repetitions, or any other suitable approach. When the training data includes multiple repetitions, each model may also be evaluated based on whether the model was able to accurately identify the correct number of repetitions. To the extent a model adds or misses a repetition, the model may be heavily penalized for purposes of evaluation.

At step 710, biometric monitoring and feedback system 408 selects the “best” model as determined by the evaluation of step 708 and, at step 712, biometric monitoring and feedback system 408 updates the classifier based on the selected model.

In some examples, the processes described herein (e.g., process 500, process 600, process 700, and/or other process and variations described herein) may be performed by a computing device or apparatus. In some examples, processes disclosed herein can be performed by user computing device 404 and/or biometric monitoring and feedback system 408, alone or in combination. Nevertheless, implementations of the present disclosure are not limited to any specific architectures disclosed herein. Rather, processes disclosed herein may be executed by any suitable computing system including any suitable number or arrangement of computing devices capable of capturing video image of a user, extracting movement data from that video, and analyzing the movement data to provide feedback to the user.

Computing devices discussed herein can include any suitable device, such as a mobile device (e.g., a mobile phone), a desktop computing device, a tablet computing device, an extended reality (XR) device or system (e.g., a VR headset, an AR headset, AR glasses, or other XR device or system), a wearable device (e.g., a network-connected watch or smartwatch, or other wearable device), a server computer or system, a robotic device, a television, and/or any other computing device with the resource capabilities to perform the processes described herein. For example, with respect to the user computing device, any suitable computing device may be used provided it includes the capability (either through integrated or peripheral components) to capture images/video of a user. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Processes disclosed herein may be illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, other processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

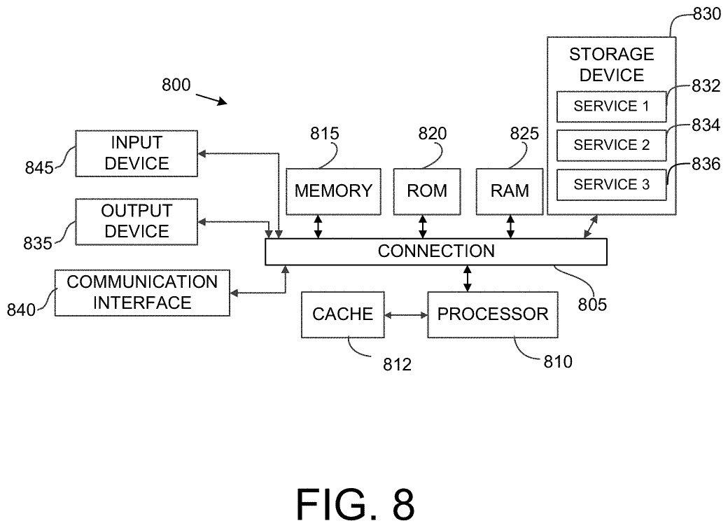

FIG. 8 shows an example of a computing system 800, which can be, for example, any computing device making up, or any component thereof in which the components of the system are in communication with each other using a connection 805. Connection 805 can be a physical connection via a bus, or a direct connection into a processor 810, such as in a chipset architecture. Connection 805 can also be a virtual connection, networked connection, or logical connection.

In some implementations, computing system 800 is a distributed system in which the functions described in this disclosure can be distributed within a datacenter, multiple data centers, a peer network, etc. In some implementations, one or more of the described system components represents many such components each performing some or all of the function for which the component is described. In some implementations, the components can be physical or virtual devices.

Example system 800 includes at least one processing unit (CPU or processor) 810 and connection 805 that couples various system components including system memory 815, such as read-only memory (ROM) 820 and random access memory (RAM) 825 to processor 810. Computing system 800 can include a cache of high-speed memory 812 connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. There is no restriction on operating on any particular hardware arrangement, and therefore the basic features here may easily be substituted for improved hardware or firmware arrangements as they are developed.

Storage device 830 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

Storage device 830 can include software services, servers, etc., that when the code that defines such software is executed by the processor 810, it causes the system to perform a function. In some implementations, a hardware service that performs a particular function can include the software component stored in a computer-readable medium in connection with the necessary hardware components, such as processor 810, connection 805, output device 835, etc., to carry out the function.

For clarity of explanation, in some instances, the present technology may be presented as including individual functional blocks including functional blocks including devices, device components, steps or routines in a method embodied in software, or combinations of hardware and software.

Any of the steps, operations, functions, or processes described herein may be performed or implemented by a combination of hardware and software services or services, alone or in combination with other devices. In some implementations, a service can be software that resides in memory of a client device and/or one or more servers of a content management system and perform one or more functions when a processor executes the software associated with the service. In some implementations, a service is a program or a collection of programs that carry out a specific function. In some implementations, a service can be considered a server. The memory can be a non-transitory computer-readable medium.

In some implementations, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can include, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to this disclosure can include hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Illustrative examples of the disclosure include:

Aspect 1-1: A computer-implemented method of analyzing bodily movement including extracting movement data from a video of a user; comparing the movement data to target movement data; and providing feedback to the user based on the comparison between the movement data and the target movement data.

Aspect 1-2: The computer-implemented method of Aspect 1-1, wherein extracting the movement data from the video comprises generating user key point data from the video, and wherein the user key point data indicates bodily locations of the user.

Aspect 1-3: The computer-implemented method of Aspect 1-2, wherein generating the user key point data from the video comprises, for each frame of one or more frames of the video, identifying the bodily locations of the user in the frame of the video.

Aspect 1-4: The computer-implemented method of Aspect 1-3, wherein identifying the bodily locations of the user in the frame comprises providing the frame to a neural network, the neural network trained to identify bodily locations relative to a received frame and to generate coordinates for identified bodily locations relative to the received frame.

Aspect 1-5: The computer-implemented method of Aspect 1-3, wherein the user key point data includes a set of coordinate pairs for each frame of the one or more frames of the video, each coordinate pair of the set of coordinate pairs indicating a respective bodily location relative to a standard frame of reference.

Aspect 1-6: The computer-implemented method of Aspect 1-5, wherein generating the user key point data further comprises transforming first location data corresponding to the bodily locations of the user relative to the frame into second location data corresponding to the bodily locations of the user relative to the standard frame of reference.

Aspect 1-7: The computer-implemented method of Aspect 1-3 further including extrapolating user key point data for a bodily location not visible within the frame.

Aspect 1-8: The computer-implemented method of Aspect 1-7, wherein extrapolating the user key point data for the bodily location not visible within the frame comprises applying a linear regression to user key point data for one or more bodily locations contained within the frame.

Aspect 1-9: The computer-implemented method of Aspect 1-1 further including classifying the movement data to identify a movement type corresponding to the movement data.

Aspect 1-10: The computer-implemented method of Aspect 1-9, wherein classifying the movement data comprises providing the movement data to a classifier, wherein the classifier is trained on one or more sets of movement data, each set of movement data indicating bodily locations during performance of a movement, and the classifier is configured to identify a movement type corresponding to movement data provided to the classifier.

Aspect 1-11: The computer-implemented method of Aspect 1-10, wherein the classifier is trained using a triplet loss function.

Aspect 1-12: The computer-implemented method of Aspect 1-11, wherein the triplet loss function implements hard negative mining.

Aspect 1-13: The computer-implemented method of Aspect 1-10, further including training the classifier using the movement data extracted from the video.

Aspect 1-14: The computer-implemented method of Aspect 1-1, wherein comparing the movement data extracted from the video to the target movement data comprises temporally aligning the movement data to the target movement data.

Aspect 1-15: The computer-implemented method of Aspect 1-14, wherein temporally aligning the movement data to the target movement data comprises identifying a starting position from the movement data and aligning the starting position with a target starting position of the target movement data.

Aspect 1-16: The computer-implemented method of Aspect 1-15, wherein:

the movement data represents a sequential series of body positions and the target movement data represents a sequential series of target body positions, and

comparing the movement data extracted from the video to the target movement data further comprises comparing a body position of the movement data to a target body position of the target movement data.

Aspect 1-17: The computer-implemented method of Aspect 1-16, wherein comparing the body position of the movement data to the target body position comprises comparing user key point data of the movement data indicating bodily locations of the user to target key point data of the target movement data indicating bodily locations of a target movement.

Aspect 1-18: The computer-implemented method of Aspect 1-16, wherein the body position of the movement data corresponds to an index in the sequential series of body positions and the target body position corresponds to an index in the sequential series of target body positions.

Aspect 1-19: The computer-implemented method of Aspect 1-18, wherein the first index is equal to the second index.

Aspect 1-20: The computer-implemented method of Aspect 1-18, wherein the second index is within a range of indices about the first index.

Aspect 1-21: The computer-implemented method of Aspect 1-1, wherein the movement data includes a portion of a repetition of a repetitive movement and providing feedback to the user comprises providing feedback to the user during performance of the repetition of the repetitive movement.

Aspect 1-22: The computer-implemented method of Aspect 1-1, wherein the movement data includes a complete repetition of a repetitive movement and providing feedback to the user comprises providing feedback to the user subsequent to completion of the repetition.

Aspect 1-23: The computer-implemented method of Aspect 1-1, wherein the movement data includes a plurality of repetitions of a repetitive movement and providing feedback to the user comprises providing feedback to the user indicating a comparison between repetitions of the plurality of repetitions.

Aspect 1-24: The computer-implemented method of Aspect 1-1 further including providing a visual representation of the target movement data to the user.

Aspect 1-25: The computer-implemented method of Aspect 1-24, wherein the visual representation includes a moving visual image of a movement corresponding to the target movement data.

Aspect 1-26: The computer-implemented method of Aspect 1-25, wherein providing feedback to the user comprises adding visual indicators to the moving visual image corresponding to deviations between the movement data of the user and the target movement data.

Aspect 1-27: The computer-implemented method of Aspect 1-25, further including modifying a play speed of the moving visual image in response to identifying a pace deviation between the movement data and the target movement data.

Aspect 1-28: The computer-implemented method of Aspect 1-25, wherein modifying the play speed comprises increasing the play speed in response to determining the pace deviation indicates the movement data indicates the user is moving at a faster pace than a pace of the target movement data.

Aspect 1-29: The computer-implemented method of Aspect 1-25, wherein modifying the play speed comprises decreasing the play speed in response to determining the pace deviation indicates the movement data indicates the user is moving at a slower pace than a pace of the target movement data.

Aspect 2-1: A system including a storage configured to store instructions; a processor configured to execute the instructions and cause the processor to: extract movement data from a video of a user, compare the movement data to target movement data, and provide feedback to the user based on the comparison between the movement data and the target movement data.

Aspect 2-2: The system of Aspect 2-1, wherein extracting the movement data from the video includes generating user key point data from the video; and extracting the movement data from the video comprises generating user key point data from the video.

Aspect 2-3: The system of Aspect 2-2, wherein generating the user key point data from the video comprises, for each frame of one or more frames of the video, identifying the bodily locations of the user in the frame of the video.

Aspect 2-4: The system of Aspect 2-3, wherein identifying the bodily locations of the user in the frame comprises providing the frame to a neural network, the neural network trained to identify bodily locations relative to a received frame and to generate coordinates for identified bodily locations relative to the received frame.

Aspect 2-5: The system of Aspect 2-3, wherein the user key point data includes a set of coordinate pairs for each frame of the one or more frames of the video, each coordinate pair of the set of coordinate pairs indicating a respective bodily location relative to a standard frame of reference.

Aspect 2-6: The system of Aspect 2-5, wherein generating the user key point data further comprises transforming first location data corresponding to the bodily locations of the user relative to the frame into second location data corresponding to the bodily locations of the user relative to the standard frame of reference.

Aspect 2-7: The system of Aspect 2-3, wherein the processor is configured to execute the instructions and cause the processor to extrapolate user key point data for a bodily location not visible within the frame.

Aspect 2-8: The system of Aspect 2-7, wherein extrapolating the user key point data for the bodily location not visible within the frame comprises applying a linear regression to user key point data for one or more bodily locations contained within the frame.

Aspect 2-9: The system of Aspect 2-1, wherein the processor is configured to execute the instructions and cause the processor to classify the movement data to identify a movement type corresponding to the movement data.

Aspect 2-10: The system of Aspect 2-9, wherein classifying the movement data comprises providing the movement data to a classifier.

Aspect 2-11: The system of Aspect 2-10, wherein the classifier is trained using a triplet loss function.

Aspect 2-12: The system of Aspect 2-11, wherein the triplet loss function implements hard negative mining.

Aspect 2-13: The system of claim Aspect 2-10, wherein the processor is configured to execute the instructions and cause the processor to train the classifier use the movement data extracted from the video.

Aspect 2-14: The system of Aspect 2-1, wherein comparing the movement data extracted from the video to the target movement data comprises temporally aligning the movement data to the target movement data.

Aspect 2-15: The system of Aspect 2-14, wherein temporally aligning the movement data to the target movement data comprises identifying a starting position from the movement data and aligning the starting position with a target starting position of the target movement data.

Aspect 2-16: The system of Aspect 2-15, wherein the movement data represents a sequential series of body positions, the target movement data represents a sequential series of target body positions, and the processor is configured to execute the instructions and cause the processor to compare the movement data extracted from the video to the target movement data by comparing a body position of the movement data to a target body position of the target movement data.

Aspect 2-17: The system of Aspect 2-16, wherein comparing the body position of the movement data to the target body position comprises comparing user key point data of the movement data indicating bodily locations of the user to target key point data of the target movement data indicating bodily locations of a target movement.

Aspect 2-18: The system of Aspect 2-16, wherein the body position of the movement data corresponds to an index in the sequential series of body positions and the target body position corresponds to an index in the sequential series of target body positions.

Aspect 2-19: The system of Aspect 2-18, wherein the first index is equal to the second index.

Aspect 2-20: The system of Aspect 2-18, wherein the second index is within a range of indices about the first index.

Aspect 2-21: The system of Aspect 2-1, wherein the movement data includes a portion of a repetition of a repetitive movement and providing feedback to the user comprises providing feedback to the user during performance of the repetition of the repetitive movement.

Aspect 2-22: The system of Aspect 2-1, wherein the movement data includes a complete repetition of a repetitive movement and providing feedback to the user comprises providing feedback to the user subsequent to completion of the repetition.

Aspect 2-23: The system of Aspect 2-1, wherein the movement data includes a plurality of repetitions of a repetitive movement and providing feedback to the user comprises providing feedback to the user indicating a comparison between repetitions of the plurality of repetitions.

Aspect 2-24: The system of Aspect 2-1, wherein the processor is configured to execute the instructions and cause the processor to provide a visual representation of the target movement data to the user.

Aspect 2-25: The system of Aspect 2-24, wherein the visual representation includes a moving visual image of a movement corresponding to the target movement data.

Aspect 2-25: The system of Aspect 2-25, wherein providing feedback to the user comprises adding visual indicators to the moving visual image corresponding to deviations between the movement data of the user and the target movement data.

Aspect 2-26: The system of Aspect 2-25, wherein the processor is configured to execute the instructions and cause the processor to modify a play speed of the moving visual image in response to identify a pace deviation between the movement data and the target movement data.

Aspect 2-28: The system of Aspect 2-25, wherein modifying the play speed comprises increasing the play speed in response to determining the pace deviation indicates the movement data indicates the user is moving at a faster pace than a pace of the target movement data.

Aspect 2-29: The system of Aspect 2-25, wherein modifying the play speed comprises decreasing the play speed in response to determining the pace deviation indicates the movement data indicates the user is moving at a slower pace than a pace of the target movement data.

Aspect 3-1: A non-transitory computer readable medium comprising instructions, the instructions, when executed by a computing system, cause the computing system to extract a movement data from a video of a user; compare the movement data to target movement data; and provide feedback to the user based on the comparison between the movement data and the target movement data.

Aspect 3-2: The computer readable medium of Aspect 3-1, extracting the movement data from the video comprises generating user key point data from the video.

Aspect 3-3: The computer readable medium of Aspect 3-2, generating the user key point data from the video comprises, for each frame of one or more frames of the video, identifying the bodily locations of the user in the frame of the video.

Aspect 3-4: The computer readable medium of Aspect 3-3, identifying the bodily locations of the user in the frame comprises providing the frame to a neural network, the neural network trained to identify bodily locations relative to a received frame and to generate coordinates for identified bodily locations relative to the received frame.

Aspect 3-5: The computer readable medium of Aspect 3-3, the user key point data includes a set of coordinate pairs for each frame of the one or more frames of the video, each coordinate pair of the set of coordinate pairs indicating a respective bodily location relative to a standard frame of reference.

Aspect 3-6: The computer readable medium of Aspect 3-5, generating the user key point data further comprises transforming first location data corresponding to the bodily locations of the user relative to the frame into second location data corresponding to the bodily locations of the user relative to the standard frame of reference.

Aspect 3-7: The computer readable medium of Aspect 3-3, wherein the computer readable medium further comprises instructions that, when executed by the computing system, cause the computing system to: extrapolate user key point data for a bodily location not visible within the frame.

Aspect 3-8: The computer readable medium of Aspect 3-7, extrapolating the user key point data for the bodily location not visible within the frame comprises applying a linear regression to user key point data for one or more bodily locations contained within the frame.

Aspect 3-9: The computer readable medium of Aspect 3-1, wherein the computer readable medium further comprises instructions that, when executed by the computing system, cause the computing system to: classify the movement data to identify a movement type corresponding to the movement data.

Aspect 3-10: The computer readable medium of Aspect 3-9, classifying the movement data comprises providing the movement data to a classifier and classifying the movement data comprises providing the movement data to a classifier.

Aspect 3-11: The computer readable medium of Aspect 3-10, the classifier is trained using a triplet loss function.

Aspect 3-12: The computer readable medium of Aspect 3-11, the triplet loss function implements hard negative mining.

Aspect 3-13: The computer readable medium of Aspect 3-10, wherein the computer readable medium further comprises instructions that, when executed by the computing system, cause the computing system to: train the classifier use the movement data extracted from the video.

Aspect 3-14: The computer readable medium of Aspect 3-1, comparing the movement data extracted from the video to the target movement data comprises temporally aligning the movement data to the target movement data.

Aspect 3-15: The computer readable medium of Aspect 3-14, temporally aligning the movement data to the target movement data comprises identifying a starting position from the movement data and aligning the starting position with a target starting position of the target movement data.

Aspect 3-16: The computer readable medium of Aspect 3-15, wherein the computer readable medium further includes instructions that, when executed by the computing system, cause the computing system to the movement data represents a sequential series of body positions and the target movement data represents a sequential series of target body positions; and compare the movement data extracted from the video to the target movement data further comprises compare a body position of the movement data to a target body position of the target movement data.

Aspect 3-17: The computer readable medium of Aspect 3-16, comparing the body position of the movement data to the target body position comprises comparing user key point data of the movement data indicating bodily locations of the user to target key point data of the target movement data indicating bodily locations of a target movement.

Aspect 3-18: The computer readable medium of Aspect 3-16, the body position of the movement data corresponds to an index in the sequential series of body positions and the target body position corresponds to an index in the sequential series of target body positions.

Aspect 3-19: The computer readable medium of Aspect 3-18, the first index is equal to the second index.

Aspect 3-20: The computer readable medium of Aspect 3-18, the second index is within a range of indices about the first index.

Aspect 3-21: The computer readable medium of Aspect 3-1, the movement data includes a portion of a repetition of a repetitive movement and providing feedback to the user comprises providing feedback to the user during performance of the repetition of the repetitive movement.

Aspect 3-22: The computer readable medium of Aspect 3-1, the movement data includes a complete repetition of a repetitive movement and providing feedback to the user comprises providing feedback to the user subsequent to completion of the repetition.

Aspect 3-23: The computer readable medium of Aspect 3-1, the movement data includes a plurality of repetitions of a repetitive movement and providing feedback to the user comprises providing feedback to the user indicating a comparison between repetitions of the plurality of repetitions.

Aspect 3-24: The computer readable medium of Aspect 3-1, wherein the computer readable medium further comprises instructions that, when executed by the computing system, cause the computing system to: provide a visual representation of the target movement data to the user.

Aspect 3-25: The computer readable medium of Aspect 3-24, the visual representation includes a moving visual image of a movement corresponding to the target movement data.

Aspect 3-26: The computer readable medium of Aspect 3-25, providing feedback to the user comprises adding visual indicators to the moving visual image corresponding to deviations between the movement data of the user and the target movement data.

Aspect 3-27: The computer readable medium of Aspect 3-25, wherein the computer readable medium further comprises instructions that, when executed by the computing system, cause the computing system to: modify a play speed of the moving visual image in response to identify a pace deviation between the movement data and the target movement data.

Aspect 3-28 The computer readable medium of Aspect 3-25, modifying the play speed comprises increasing the play speed in response to determining the pace deviation indicates the movement data indicates the user is moving at a faster pace than a pace of the target movement data.

Aspect 3-29: The computer readable medium of Aspect 3-25, modifying the play speed comprises decreasing the play speed in response to determining the pace deviation indicates the movement data indicates the user is moving at a slower pace than a pace of the target movement data.

Aspect 4-1: A computer-implemented method including extracting key point data for frames of a video, wherein the key point data includes bodily locations of a user portrayed in the video; applying a clustering operation to the key point data to identify a cluster for each frame; and applying a respective label to each frame according to the cluster identified for the frame.

Aspect 4-2: The computer-implemented method of Aspect 4-1, further including receiving the video and extracting each of the frames from the video.

Aspect 4-3: The computer-implemented method of Aspect 4-1, further including receiving the video and extracting each of the frames from the video, wherein extracting each of the frames of the video includes at least one of ignoring frames at a start of the video, ignoring frames at an end of the video, or trimming the video prior to extracting each of the frames.

Aspect 4-4: The computer-implemented method of Aspect 4-1, wherein the frames are a subset of all frames included in the video.

Aspect 4-5: The computer-implemented method of Aspect 4-1, wherein applying the clustering operation clusters the frames into two groups, the two groups corresponding to a start and end position of a movement.

Aspect 4-6: The computer-implemented method of Aspect 4-1, wherein applying the clustering operation clusters the frames into greater than two groups, each group corresponding to a key position of a movement.

Aspect 4-7: The computer-implemented method of Aspect 4-1 further including applying a smoothing operation to the labels of the frames.

Aspect 4-8: The computer-implemented method of Aspect 4-1 further including applying a smoothing operation to the labels of the frames, wherein the smoothing operation includes identifying and changing instances of a first label disposed between instances of a second label.

Aspect 4-9: The computer-implemented method of Aspect 4-1 further including applying a smoothing operation to the labels of the frames, wherein the smoothing operation includes identifying and changing instances of a first label disposed between instances of a second label, wherein at least one of quantity of instances of the first label are below a first predetermined threshold and a quantity of instances of the second label are above a second predetermined threshold.

Aspect 4-10: The computer-implemented method of Aspect 4-1 further including applying a smoothing operation to the labels of the frames, wherein the smoothing operation includes identifying and changing instances of a first label disposed between instances of a second label, wherein at least one of quantity of instances of the first label is below five and a quantity of instances of the second label are above five.

Aspect 4-11: The computer-implemented method of Aspect 4-1 further including executing a model training operation using the labels of the frames and the key point data, wherein the model training operation is to train a model for identifying a user movement included in the video.

Aspect 4-12: The computer-implemented method of Aspect 4-1 further including executing a model evaluation operation using the labels of the frames and the key point data, wherein the model evaluation operation is to evaluate a model for identifying a user movement included in the video

Aspect 5-1: A system including a storage configured to store instructions and a processor configured to execute the instructions and cause the processor to perform any of the methods of Aspect 4-1 to 4-12.

Aspect 6-1: A non-transitory computer readable medium including instructions, wherein, when executed by a computing system, the instructions cause the computing system to perform any of the methods of Aspect 4-1 to 4-12.

Aspect 7-1: A computer-implemented method including obtaining a plurality of hyperparameter values; obtaining training data including key point data indicating bodily locations of a user in frames of a video and corresponding labels for each frame; generating multiple candidate models, wherein each candidate model is generated using a unique combination of training data and hyperparameter values; selecting a model of the candidate models based on one or more evaluation criteria; and integrating the model into a classifier configured to identify movement types from key point data.

Aspect 7-2: The computer-implemented method of Aspect 7-1, wherein the hyperparameter values include values for at least one of a neural network stopping patience and a gradient descent optimizer learning rate.

Aspect 7-3: The computer-implemented method of Aspect 7-1, wherein obtaining the training data includes obtaining original key point data and generating the training data by augmenting the original key point data.

Aspect 7-4: The computer-implemented method of Aspect 7-1, wherein obtaining the training data includes obtaining original key point data and generating the training data by augmenting the original key point data, wherein augmenting the original key point data includes at least one of flipping coordinates of key points about an axis, adding noise to key point coordinates, displacing key point coordinates by a fixed amount, increasing scaling of the key point coordinates, decreasing scaling of the key point coordinates, and reversing key point coordinates.

Aspect 7-5: The computer-implemented method of Aspect 7-1, wherein the training data includes multiple subsets of training data and obtaining the training data includes obtaining original key point data and, for each subset of training data, augmenting the original key point data using a respective set of augmentations to generate the subset of training data.

Aspect 7-6: The computer-implemented method of Aspect 7-1, wherein selecting the model of the candidate models includes providing evaluation data to each candidate model and analyzing the output of each model based on the one or more evaluation criteria.

Aspect 7-7: The computer-implemented method of Aspect 7-1, wherein the one or more evaluation criteria includes accuracy of labels output by the candidate models to labels included in evaluation data, the evaluation data corresponding to frames of a video and including, for each frame, a label indicating a closest key position for a movement of a user shown in the video.

Aspect 7-8: The computer-implemented method of Aspect 7-1, wherein the one or more evaluation criteria includes a confidence metric.

Aspect 7-9: The computer-implemented method of Aspect 7-1, wherein the one or more evaluation criteria includes a noisiness metric.

Aspect 8-1: A system including a storage configured to store instructions and a processor configured to execute the instructions and cause the processor to perform any of the methods of Aspect 7-1 to 7-9.

Aspect 9-1: A non-transitory computer readable medium including instructions, wherein, when executed by a computing system, the instructions cause the computing system to perform any of the methods of Aspect 7-1 to 7-9.

What is claimed is:

1. A computer-implemented method of analyzing bodily movement comprising:
extracting movement data from a video of a user;
identifying a movement type by providing the movement data to a classifier, wherein the classifier is trained using data including bodily locations for a plurality of movement types including the movement type;
comparing the movement data to target movement data for the movement type; and
providing feedback to the user based on the comparison between the movement data and the target movement data.

2. The computer-implemented method of claim 1, wherein:
extracting the movement data from the video includes generating user key point data for multiple frames of the video, the user key point data corresponding to bodily locations of the user in each of the multiple frames, and
generating the user key point data includes providing the frame to a model trained to identify bodily locations in a received frame and to output coordinate pairs for identified bodily locations relative to the received frame.

3. The computer-implemented method of claim 1, further comprising training the classifier using the movement data extracted from the video of the user.

4. The computer-implemented method of claim 1, wherein comparing the movement data extracted from the video to the target movement data includes temporally aligning the movement data to the target movement data by identifying a starting position from the movement data and aligning the starting position with a target starting position of the target movement data.

5. The computer-implemented method of claim 4, wherein:
the movement data represents a sequential series of body positions and the target movement data represents a sequential series of target body positions, and
comparing the movement data extracted from the video to the target movement data further includes comparing a body position of the movement data to a target body position of the target movement data.

6. The computer-implemented method of claim 5, wherein comparing the body position of the movement data to the target body position includes comparing user key point data of the movement data indicating bodily locations of the user to target key point data of the target movement data indicating bodily locations of a target movement.

7. The computer-implemented method of claim 1 further comprising providing a visual representation of the target movement data to the user, the visual representation including a moving visual image of a movement corresponding to the target movement data.

8. A system comprising:
a storage configured to store instructions;
a processor configured to execute the instructions and cause the processor to:
extract movement data from a video of a user;
identify a movement type by providing the movement data to a classifier, wherein the classifier is trained using data including bodily locations for a plurality of movement types including the movement type;
compare the movement data to target movement data for the movement type; and
provide feedback to the user based on the comparison between the movement data and the target movement data.

9. The system of claim 8, wherein the instructions further cause the processor to:
extract the movement data from the video by generating user key point data for multiple frames of the video, the user key point data corresponding to bodily locations of the user in each of the multiple frames, and
generate the user key point data by providing the frame to a model trained to identify bodily locations in a received frame and to output coordinate pairs for identified bodily locations relative to the received frame.

10. The system of claim 8, wherein the instructions further cause the processor to train the classifier using the movement data extracted from the video of the user.

11. The system of claim 8, wherein the instructions cause the processor to temporally align the movement data to the target movement data by identifying a starting position from the movement data and aligning the starting position with a target starting position of the target movement data.

12. The system of claim 11, wherein the movement data represents a sequential series of body positions and the target movement data represents a sequential series of target body positions, and wherein the instructions cause the processor to compare the movement data extracted from the video to the target movement data further by comparing a body position of the movement data to a target body position of the target movement data.

13. The computer-implemented method of claim 12, wherein the instructions cause the processor to compare the body position of the movement data to the target body position by comparing user key point data of the movement data indicating bodily locations of the user to target key point data of the target movement data indicating bodily locations of a target movement.

14. The computer-implemented method of claim 1, wherein the instructions further cause the processor to provide a visual representation of the target movement data to the user, the visual representation including a moving visual image of a movement corresponding to the target movement data.

15. A non-transitory computer readable medium comprising instructions, the instructions, when executed by a computing system, cause the computing system to:
extract movement data from a video of a user;
identify a movement type by providing the movement data to a classifier, wherein the classifier is trained using data including bodily locations for a plurality of movement types including the movement type;
compare the movement data to target movement data for the movement type; and
provide feedback to the user based on the comparison between the movement data and the target movement data.

16. The non-transitory computer readable medium of claim 15, wherein the instructions further cause the computing system to:
extract the movement data from the video by generating user key point data for multiple frames of the video, the user key point data corresponding to bodily locations of the user in each of the multiple frames, and
generate the user key point data by providing the frame to a model trained to identify bodily locations in a received frame and to output coordinate pairs for identified bodily locations relative to the received frame.

17. The non-transitory computer readable medium of claim 15, wherein the instructions further cause the computing system to train the classifier using the movement data extracted from the video of the user.

18. The non-transitory computer readable medium of claim 15, wherein:
the instructions cause the computing system to temporally align the movement data to the target movement data by identifying a starting position from the movement data and aligning the starting position with a target starting position of the target movement data,
the movement data represents a sequential series of body positions and the target movement data represents a sequential series of target body positions, and
the instructions cause the computing system to compare the movement data extracted from the video to the target movement data further by comparing a body position of the movement data to a target body position of the target movement data.

19. The non-transitory computer readable medium of claim 18, wherein the instructions cause the processor to compare the body position of the movement data to the target body position by comparing user key point data of the movement data indicating bodily locations of the user to target key point data of the target movement data indicating bodily locations of a target movement.

20. The non-transitory computer readable medium of claim 15, wherein the instructions further cause the computing system to provide a visual representation of the target movement data to the user, the visual representation including a moving visual image of a movement corresponding to the target movement data.
